(19) United States
(12) Patent Application Publication
(10) Pub. No.: US 2023/0009073 A1
(43) Pub. Date: Jan. 12, 2023

(54) SELF-LOCALIZATION OF A VEHICLE BASED ON AN INITIAL POSE

(71) Applicant: Cariad SE, Wolfsburg (DE)

(72) Inventors: Michael Holicki, Berlin (DE); Ralph Hänsel, Berlin (DE); Timo Iken, Wolfsburg (DE); Roland Kube, Schwülper (DE); Carolin Last, Braunschweig (DE); Stefan Wappler, Berlin (DE)

(21) Appl. No.: 17/860,930

(22) Filed: Jul. 8, 2022

(30) Foreign Application Priority Data
Jul. 9, 2021 (DE) 102021117744.8

(51) Int. Cl. G08G 1/14; G06V 20/58

(52) U.S. Cl. CPC G08G 1/146; G08G 1/149; G06V 20/586

(57) ABSTRACT

According to a method for self-localization, a vehicle is detected by a vehicle-external sensor system of a parking infrastructure when it is located in a detection region of the vehicle-external sensor system. By way of a vehicle-external communication interface of the parking infrastructure, position information regarding the detection region is relayed in dependence on the detection of the vehicle to at least one vehicle computer unit and an initial pose of the vehicle is determined by the at least one vehicle computer unit in dependence on the position information.

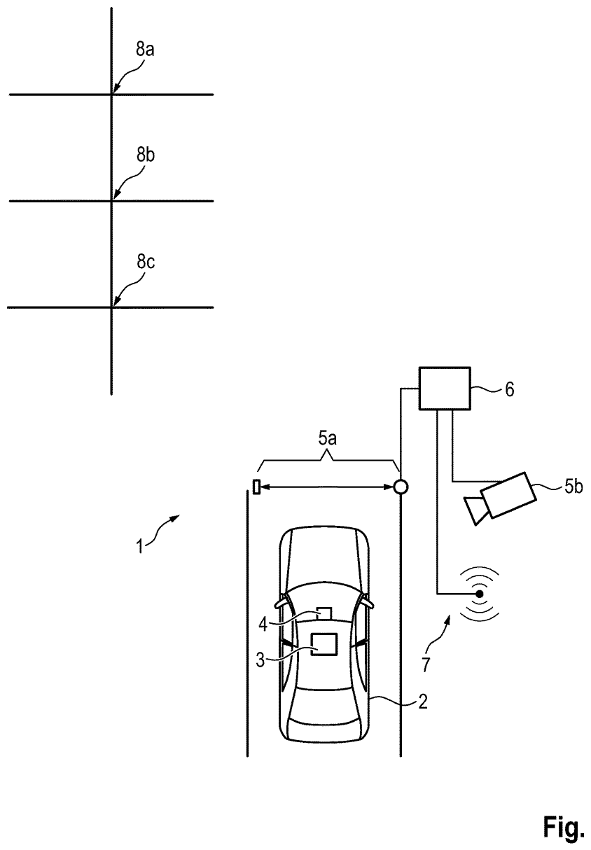

### BACKGROUND

### Technical Field

Embodiments of the invention relate to a method and a system for self-localization of a vehicle in a parking structure or infrastructure.

### Description of the Related Art

Map-based self-localization methods can be advantageous, especially for autonomous vehicles or partly automated driving functions, for example in a parking environment. Such self-localization methods are based on a comparing of objects which have been detected by way or by means of environment sensor systems against objects from a digital map. From this comparison, the position of the vehicle is determined. Such objects can also be called landmarks.

Global self-localization methods work without prior information as to the pose of the vehicle. Such methods require strictly distinct and unmistakable landmarks, such as AR-markers. Local self-localization method employ an initial pose estimation for the vehicle. These methods have the advantage of being able to work as well with landmarks that are not globally distinct.

One possibility for the initial pose estimation is to evaluate signals of a global navigation satellite system, or GNSS. This has the disadvantage that the reception of GNSS signals may be impaired by environmental conditions, especially in parking structures. The initial pose estimation is therefore possibly imprecise and/or unreliable, which may therefore lead to an imprecise and/or unreliable self-localization of the vehicle.

Document DE 10 2014 218 456 A1 describes a guidance system of a vehicle and a method for parking the vehicle in a parking facility, wherein the guidance system comprises at least one sensor, such as a camera, and a control mechanism for processing the sensor data of the sensor. The sensor of the vehicle can detect signaling elements arranged in the parking facility, such as optical light strips, and the control mechanism can evaluate the sensor data, recognize the signaling elements, and generate control commands for an actuator of the vehicle to control the vehicle and park the vehicle autonomously.

### BRIEF SUMMARY

Some embodiments enhance the accuracy and/or reliability of the self-localization of a vehicle.

Embodiments of the invention are based on the idea of detecting the vehicle by way of a vehicle-external sensor system and providing to the vehicle corresponding position information so that a vehicle computer unit can determine the initial pose of the vehicle.

In some embodiments, a method for self-localization of a vehicle, especially a motor vehicle, in a parking infrastructure is specified, wherein the vehicle is detected by means of a vehicle-external sensor system of the parking infrastructure when the vehicle is located in a detection region of the vehicle-external sensor system. By means of a vehicle-external communication interface of the parking infrastructure, position information regarding the detection region is relayed in dependence on the detection of the vehicle to at least one vehicle computer unit, especially via a communication interface of the vehicle or the vehicle computer unit. An initial pose of the vehicle is determined by means of the at least one vehicle computer unit in dependence on the position information.

In particular, self-localization can mean that the vehicle itself, especially the vehicle computer unit, determines the initial pose and/or another pose at a later time.

The parking infrastructure can be for example a parking structure, a parking place or some other parking area. The parking infrastructure has multiple parking places in which motor vehicles can be parked, especially automobiles. For example, it may be a parking infrastructure for valet parking, in which case the vehicle is brought by a human driver or user up to an entry zone of the parking infrastructure. The driver or user can then leave the vehicle and the vehicle can then be parked autonomously.

The method is thus a method for self-localization of a fully autonomously drivable vehicle, also known as a self-driving vehicle. In other embodiments, however, the vehicle is not necessarily configured for fully autonomous driving. For example, the self-localization can then be used for partially autonomous driving functions or for driver assistance.

The vehicle-external sensor system or the detection region can be arranged for example in the entrance zone or in proximity to the entrance zone.

The vehicle-external sensor system can be of different kinds in different embodiments of the method. For example, it may have one or more cameras, one or more light barriers or one or more other optical sensors. The vehicle-external sensor system may also contain an inductive sensor, such as one or more induction coils, which can be integrated for example in a roadway. And the vehicle-external sensor system can also contain a manually operated button, knob, or touch-sensitive surface, such as a soft key or a touch-sensitive monitor screen. The vehicle-external sensor system can furthermore contain an evaluation unit, which can evaluate and/or process the detected raw data, in order to detect the vehicle in the detection region.

The detection region can then correspond for example to a visual field or detection region of the one or more cameras, the one or more optical sensors, the light barriers or the inductive sensor. The detection region can also correspond to a predetermined region around the button, knob, et cetera.

Here and in the following the term “light” can be understood to mean electromagnetic waves in the visible range, the infrared range, and/or the ultraviolet range. Accordingly, the term “optical” can also be understood to refer to light with this understanding.

The pose of the vehicle contains the position of the vehicle and it can contain for example the orientation of the vehicle, especially in a map coordinates system of a given digital map. The initial pose thus corresponds to a combination of an initial position and/or initial orientation in the map coordinates system. The position and the location of the detection region in the map coordinates system are known in advance. Thus, from the position information regarding the detection region, one can infer the initial position of the vehicle and possibly the initial orientation of the vehicle, so that in particular the initial pose can be estimated or delimited. In different embodiments, further information or assumptions as to the relative position and/or relative orientation of the vehicle within the detection region can be used. For example, if the detection region corresponds to a segment of a roadway, then it can be assumed that the initial orientation of the vehicle corresponds to that of the roadway, and so forth. Alternatively, the relative orientation and/or the relative position of the vehicle in the detection region can also be determined based on sensor data of the vehicle-external sensor system, for example based on corresponding camera pictures.

The initial pose can be considered to be the result of the method for self-localization. But the initial pose can also be used as the starting point for an estimation of a later pose or a pose at a later time of the vehicle within the parking infrastructure.

By determining the initial pose, possibly indistinct landmarks in the parking infrastructure such as lane marking lines or intersection points of lane marking lines and so forth can be distinctly determined in combination with the initial pose. Thus, a more reliable or more accurate self-localization of the vehicle can be achieved.

Because the position information is acquired and provided by the vehicle-external sensor system, which is arranged locally in the parking infrastructure, inaccuracies in the determination of the initial pose due to limited satellite reception of the like can be avoided.

According to at least one embodiment of the method for self-localization, environment sensor data are generated by means of an environment sensor system of the vehicle, representing an environment of the vehicle. A landmark in the environment is detected by means of the at least one vehicle computer unit based on the environment sensor data. The detected landmark is compared by means of the at least one vehicle computer unit against a digital map. A current pose of the vehicle is determined by means of the at least one vehicle computer unit depending on the initial pose and the result of the comparison.

The digital map, which can also be called a high-definition or HD map, can be saved for example on a storage element of the vehicle, especially the at least one vehicle computer unit. Alternatively or additionally, the digital map can be saved on a vehicle-external storage element of the parking infrastructure. The digital map can then be relayed for example by means of the vehicle-external communication interface to the at least one vehicle computer unit in order to make possible the comparison.

The position information regarding the detection region may contain, for example, a position and/or orientation of the detection region in the map coordinates system. Alternatively or additionally, the position information can also contain the relative position and/or relative orientation of the vehicle within the detection region. The position information can also be called pose information.

The detecting of the landmarks involves, for example, the determining of a relative position and/or orientation of the landmarks with respect to the vehicle, i.e., in a predetermined sensor coordinates system of the environment sensor system or a predetermined vehicle coordinates system of the vehicle, as well as the determining of one or more descriptors of the landmarks. The descriptors can involve, for example, the type, the size, and/or other attributes of the landmarks.

The landmarks can be, for example, one or more lane marking lines, an intersection of lane marking lines, a traffic or information sign or some other sign, a metallic structure, such as one in or on a wall or some other part of a building of the parking infrastructure, or some other component of the parking infrastructure.

The position and/or orientation of the landmarks is dictated in the map coordinates system and stored in the map. The comparing of the detected landmarks against the digital map therefore involves the determining where in the map coordinates system a landmark with corresponding descriptors is situated. In the case of globally indistinct landmarks, such as lane marking lines or intersections of lane marking lines, such a comparison may potentially yield multiple possibilities. By the combination of the result of the comparison with the initial pose, the landmark can be distinctly identified in the digital map. Since the relative position of the landmark with regard to the vehicle is known from the environment sensor data, the current pose of the vehicle can therefore be determined based on the position of the identified landmark in the map coordinates system.

The environment sensor system of the vehicle can have, for example, one or more cameras, lidar systems or other optical sensor systems, one or more ultrasound sensor systems and/or one or more radar systems.

According to at least one embodiment, in the course of the comparing, i.e., especially in order to perform the comparing of the detected landmark against the digital map, two or more reference landmarks that are stored in the digital map are identified, especially by means of the at least one vehicle computer unit. Depending on the initial pose, precisely one of the two or more reference landmarks is selected by means of the at least one vehicle computer unit. The current pose is determined based on the selected reference landmark by means of the at least one vehicle computer unit.

The two or more reference landmarks correspond to the several possibilities described above to produce the comparison for a landmark of the digital map. Thus, a distinct self-localization of the vehicle can be achieved, even when the landmarks in themselves are at first not globally distinct.

According to at least one embodiment, the digital map is relayed by means of the vehicle-external communication interface to the at least one vehicle computer unit, in particular before the comparing of the detected landmark against the digital map.

This has the advantage that map information of different parking infrastructures and so forth does not need to be stored on the vehicle itself, but instead the particular relevant digital map of the specific parking infrastructure can also be provided in reliable manner.

According to at least one embodiment, by means of a signal source of the vehicle-external sensor system. an electromagnetic signal is emitted in the direction of the detection region, especially the vehicle when the vehicle is located in the detection region. Portions of the electromagnetic signal reflected by the vehicle are detected by means of a detector of the vehicle-external sensor system and the vehicle is detected in the detection region in dependence on the detected reflected portions by means of the vehicle-external sensor system.

The electromagnetic signal can be a radio signal, especially a radio signal suitable for a radar system, an optical signal, i.e., in particular a light signal, such as a laser signal, or any other electromagnetic signal.

In other words, the vehicle-external sensor system in such embodiments comprises an active sensor system, which in the case of light being used as the electromagnetic signal can also be called an active optical sensor system.

According to at least one embodiment, by means of a signal source of the vehicle-external sensor system, especially by means of a light source, a light beam is emitted in the direction of the vehicle, especially in the direction of the detection region or into the detection region, if the vehicle is located in the detection region. An interruption of the light beam by the vehicle is recognized by means of the vehicle-external sensor system in order to detect the vehicle in the detection region.

In other words, the vehicle-external sensor system in such embodiments comprises a light barrier.

According to at least one embodiment, by means of a camera of the vehicle-external sensor system a camera image is generated, depicting the vehicle, especially the vehicle in the detection region as well as the detection region, in order to detect the vehicle in the detection region.

For this, the camera image can be evaluated, for example by means of the evaluation unit of the vehicle-external sensor system, in order to identify the vehicle in the detection region, in particular, to identify it as a vehicle or as a particular vehicle and to detect it accordingly.

According to at least one embodiment, based on the camera image, a relative position of the vehicle in the camera image and/or a relative orientation of the vehicle in the camera image are identified, especially by means of the evaluation unit of the vehicle-external sensor system. The relative position and/or the relative orientation in the camera image is relayed by means of the vehicle-external communication interface to the at least one vehicle computer unit. The initial pose of the vehicle is identified in dependence on the relative position and/or the relative orientation of the vehicle in the camera image, especially by means of the at least one vehicle computer unit.

In alternative embodiments, the vehicle-external communication interface relays the camera image to the at least one vehicle computer unit and the at least one vehicle computer unit determines the relative position of the vehicle in the camera image and/or the relative orientation of the vehicle in the camera image based on the camera image.

For example, based on the camera image it is possible to detect an identification plate, also known as a number plate, of the vehicle and read this out. Then the correspondingly established relative position and/or orientation of the identification plate in the camera image and thus in the map coordinates system can be provided by means of the vehicle-external communication interface to the vehicle, especially the at least one vehicle computer unit. The at least one vehicle computer unit can then determine the initial pose based on this.

In order to assure the necessary data security, corresponding encryption methods can be used.

According to at least one embodiment, a user interface is actuated especially by means of a user or driver of the vehicle in order to open a device blocking a roadway for the vehicle. The actuating of the user interface, which can in particular be part of the vehicle-external sensor system, is detected by means of the vehicle-external sensor system, in order to detect the vehicle in the detection region.

The device for blocking the roadway can be, for example, a barrier, a roll-down gate, or some other barrier. The user interface can have one or more knobs, buttons, soft keys and/or hard keys. The user interface can also have a card reader unit for reading a user card, such as for wireless reading of a user card, which is actuated by the user holding it up or inserting it.

In this way, the interaction points already present in the parking infrastructure can act as the vehicle-externals sensor system or as part of the vehicle-external sensor system or as input for the vehicle-external sensor system.

In some embodiments, a system for self-localization of a vehicle in a parking infrastructure is specified. The system comprises a vehicle-external sensor system, which is adapted to detect the vehicle when the vehicle is located in a detection region of the vehicle-external sensor system. The system for self-localization comprises at least one vehicle computer unit for the vehicle, as well as a vehicle-external communication interface for the parking infrastructure. The vehicle-external communication interface is adapted to relay position information regarding the detection region to the at least one vehicle computer unit in dependence on the detection of the vehicle. For this, the system can comprise, for example, a vehicle communication interface for the vehicle, which is adapted to receive the position information. The at least one vehicle computer unit is adapted to determine an initial pose of the vehicle in dependence on the position information.

Further embodiments of the system for self-localization will emerge from the different embodiments of the method for self-localization and vice versa. In particular, a system can be adapted to carry out a method as described herein, or it carries out such a method.

Further features will emerge from the claims, the figures, and the description of the figures. The features and combinations of features mentioned above in the specification, as well as the features and combinations of features mentioned below in the description of the figures and/or the features and combinations of features shown in the figures can be encompassed not only in the particular indicated combination, but also in other combinations. In particular, embodiments and combinations of features can be provided in accordance with the description herein.

### BRIEF DESCRIPTION OF THE SEVERAL VIEWS OF THE DRAWINGS

The FIGURE shows, schematically, an embodiment of a system for self-localization of a vehicle in a parking infrastructure.

### DETAILED DESCRIPTION

In the embodiments described herein, the components described each represent individual features to be viewed independently of each other, which may also develop further independently of each other and therefore should also be viewed as part of the disclosure individually or in a combination other than the one shown. Furthermore, the embodiments described can also be supplemented with other of the features already described.

The FIGURE shows the vehicle 2, which finds itself in the access zone of a parking infrastructure. The system 1 for self-localization of the vehicle 2 comprises a vehicle computer unit 3, which can contain for example one or more electronic controllers or electronic control units ECU of the vehicle 2 or be part of an ECU. The system 1 furthermore comprises a vehicle-external sensor system, for example, a light barrier 5a and/or a camera 5b, as well as an evaluation unit 6 coupled to the light barrier 5a and/or the camera 5b. The system 1 furthermore comprises a vehicle-external communication interface 7 connected to the evaluation unit 6 or the vehicle-external sensor system for wireless transmission of data to the vehicle computer unit 3.

Now, when the vehicle 2 drives through the detection region of the light barrier 5a, the evaluation unit 6 recognizes the presence of the vehicle 2 in the corresponding detection region. The position of the light barrier 5a is stored in a predetermined digital map (not shown). The digital map can be stored on the evaluation unit 6 and/or the vehicle computer unit 3 and/or some other computing unit of the parking infrastructure. In response to the detection of the vehicle 2 crossing the light barrier 5a, the evaluation unit 6 can transmit corresponding position information to the vehicle computer unit 3 via the vehicle-external communication interface 7. The vehicle computer unit 3 can then determine the initial position of the vehicle 2 in the map coordinates system of the digital map based on the position information. For example, the roadway in the detection region or in the entry zone of the parking infrastructure may likewise be indicated, so that the vehicle computer unit 3 can determine the initial pose of the vehicle 2.

Alternatively or additionally to the detection of the vehicle 2 by means of the light barrier 5a, the camera 5b can generate a camera image, depicting the vehicle 2 in the visual field of the camera 5b and based on this the evaluation unit 6 can relay the position information to the vehicle computer unit 3 via the communication interface 7.

The camera 5b for example can be calibrated and measured in the map coordinates system so that the corresponding visual field is known precisely in the map coordinates system.

Instead of or in addition to the light barrier 5a, a mechanical barrier can also be used, such as one which can be opened by pressing a button, so that it is also possible to transmit for example information as to the entry lane where the vehicle 2 is situated, in order to determine even more accurately the position and/or orientation of the vehicle 2.

Based on the camera image, the evaluation unit 6 in various embodiments can also detect and read out a number plate of the vehicle 2 and relay to the vehicle 2 the thus determined position of its own number plate. In order to prevent the data regarding the number plate from being read by other possibly unauthorized vehicles or persons, an encryption method can be used, such as an encryption method relying on a public key.

For this, for example, each vehicle can send a corresponding public key to the parking infrastructure, especially the evaluation unit 6. The evaluation unit 6 can then encrypt the detected data based on the camera image with the corresponding public key and provide this data over a public transmission pathway. Each of the vehicles can use its corresponding private key to decrypt the message intended for the particular vehicle.

The radio transmission pathways for transmission of the position information can also be used in various embodiments for the transmission of other information. Thus, for example, the vehicle 2 can send to the evaluation unit 6, as just described, the public key or other vehicle-specific information relevant to the parking, such as a handicapped condition of the driver, the size or the excessive size of the vehicle, and so forth. The evaluation unit 6 can also send to the vehicle computer unit 3 a public key for safeguarding the upload data, the digital map, a position of a target parking place and/or a proposed route to the target parking place via the communication interface 7.

After the initial pose of the vehicle 2 has been determined, the vehicle 2 can move into the parking infrastructure, for example autonomously. At a later time, an environment sensor system 4 of the vehicle 2, such as a radar system, a lidar system and/or a camera system of the vehicle 2 can generate corresponding environment sensor data in order to detect landmarks 8a, 8b, 8c present in the parking infrastructure. In the non-limiting example of the FIGURE, the landmarks 8a, 8b, 8c may contain intersections of lane marking lines, for example to define the parking places.

The detected landmark 8a, 8b, 8c can be compared by means of the vehicle computer unit 3 against the digital map and it can be identified distinctly together with the initial pose, so that a current or relevant pose of the vehicle 2 can be determined with high accuracy and reliability.

As described in particular with respect to the FIGURE, some embodiments make it possible to achieve a greater accuracy and reliability in the self-localization of vehicles, especially autonomous vehicles. In particular, some embodiments make it possible to work locally with landmarks which are not necessarily globally distinct, such as the marking lines of parking bays and so forth.

Since autonomous driving functions in particular are security-relevant, it can be assured in various embodiments that the processed information meets the corresponding security classification or the corresponding security requirements, such as those of ASIL-B. Thus, in various embodiments the initial pose of the vehicle can be determined at a time when a human operator is still controlling the vehicle, or at least before the human operator leaves the vehicle. The landmark-based localization thereby initiated can then make the initial pose more plausible and possibly refine it, and the autonomous driving can be commenced only when the self-localization has achieved an adequate degree of security.

Additional security can be achieved by a combination of different pose estimation methods.

In various embodiments, the initial pose can be determined with the aid of inconspicuous markers or markers already present in the parking infrastructure, for example, in addition to the described determination with the aid of the vehicle-external sensor system, in order to create enhanced security and reliability through redundancy, for example. The inconspicuous markers may contain, for example, logos or advertising signs, or other objects whose position is known in the coordinates of the digital map. These markers can be detected by the environment sensor system of the vehicle, in particular the vehicle camera. Since both the size and the position of the marker are known in the map coordinates, the vehicle can thus determine its initial pose. The use of inconspicuous markers can be used to refine the information based on the vehicle-external sensor system, or standing alone. In such embodiments it is possible to evaluate not just geometrical properties of the marker, but also content qualities of the marker, such as text or picture contents and so forth, in order to achieve the most distinct possible and globally unmistakable pose estimation.

German patent application no. 10 2021 117744.8, filed Jul. 9, 2021, to which this application claims priority, is hereby incorporated herein by reference, in its entirety. Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for self-localization of a vehicle in a parking structure, comprising:
detecting the vehicle, by a vehicle-external sensor system of the parking structure, when the vehicle is located in a detection region of the vehicle-external sensor system;
relaying position information regarding the detection region, in dependence on detection of the vehicle, by a vehicle-external communication interface of the parking structure, to at least one vehicle computer unit; and
determining an initial pose of the vehicle, by the at least one vehicle computer unit, in dependence on the position information.

2. The method according to claim 1, wherein:
environment sensor data are generated by an environment sensor system of the vehicle, representing an environment of the vehicle;
a landmark in the environment is detected by the at least one vehicle computer unit based on the environment sensor data;
the detected landmark is compared by the at least one vehicle computer unit against a digital map; and
a detected pose of the vehicle is determined by the at least one vehicle computer unit depending on the initial pose and the result of the comparison.

3. The method according to claim 2, wherein:
in the course of the comparing of the detected landmark against the digital map, two or more reference landmarks that are stored in the digital map are identified;
depending on the initial pose, precisely one of the two or more reference landmarks is selected; and
the current pose is determined based on the selected reference landmark.

4. The method according to claim 2, wherein the digital map is relayed by the vehicle-external communication interface to the at least one vehicle computer unit.

5. The method according to claim 1, wherein:
an electromagnetic signal is emitted in the direction of the vehicle by a signal source of the vehicle external sensor system;
portions of the electromagnetic signal reflected by the vehicle are detected by a detector of the vehicle-external sensor system; and
the vehicle is detected in the detection region in dependence on the detected reflected portions.

6. The method according to claim 1, wherein:
a light beam is emitted in the direction of the vehicle by a signal source of the vehicle external sensor system;
an interruption of the light beam by the vehicle is recognized by the vehicle-external sensor system in order to detect the vehicle in the detection region.

7. The method according to claim 1, wherein a camera image is generated by a camera of the vehicle external sensor system, the image depicting the vehicle, in order to detect the vehicle in the detection region.

8. The method according to claim 7, wherein:
based on the camera image, a relative position of the vehicle in the camera image and/or a relative orientation of the vehicle in the camera image is identified; and
the initial pose of the vehicle is determined in dependence on the relative position and/or the relative orientation.

9. The method according to claim 1, wherein:
a user interface is actuated in order to open a device blocking a roadway for the vehicle;
the actuating of the user interface is detected by the vehicle-external sensor system, in order to detect the vehicle in the detection region.

10. A system for self-localization of a vehicle in a parking structure, comprising:
a vehicle-external sensor system, which is adapted to detect the vehicle when the vehicle is located in a detection region of the vehicle-external sensor system; and
at least one vehicle computer unit as well as a vehicle-external communication interface, which is adapted to relay position information regarding the detection region to the at least one vehicle computer unit in dependence on the detection of the vehicle;
wherein the at least one vehicle computer unit is adapted to determine an initial pose of the vehicle in dependence on the position information.
